(19) United States
(12) Patent Application Publication
(10) Pub. No.: US 2021/0227781 A1
(43) Pub. Date: Jul. 29, 2021

(54) CUSTOM KITTY LINERS & SIFTERS

(71) Applicant: Tonya Penn-Awkard, Philadelphia, PA (US)

(72) Inventor: Tonya Penn-Awkard, Philadelphia, PA (US)

(21) Appl. No.: 17/233,450

(22) Filed: Apr. 17, 2021

(51) Int. Cl. A01K 1/01

(52) U.S. Cl. CPC A01K 1/0114

(57) ABSTRACT

A customizable liner and sifter set, with a flat bottom, for an animal litter box and the method to use the said liner and sifter is disclosed. Some animals that use a litter box include a cat, rabbit, ferret, small pigs & small dogs. The size of a customizable litter liner and sifter can be a square, rectangular, cross-shaped, or oblong shaped that tightly fits into the animal litter box of various sizes and shapes. The said customizable liner and sifter set are specifically designed to facilitate the cleanup process of the animal excrement and to make the cleaning chore easy and less unpleasant. The novel customizable liner of the present invention tightly fits into the bottom and upper lip of the designated animal litter box and when filled with litter separates the animal litter box and the litter. It is easily removable by gathering up the drawtapes, and discarding the whole liner, litter & waste into the trash. The novel sifter disclosed in the present invention contains approximately 200 two inch slits at the bottom & sides which when gathered up by the drawtapes will allow the separation and drainage of clean litter from the clumped and soiled litter thus simultaneously recycling the clean litter and eliminating the animal waste to be discarded.

### FIELD OF THE INVENTION

The present invention belongs to the field of litter box liners and sifters for animals. A liner, a sifter, and a method of using the combination of the said liner and sifter are disclosed. The present invention relates to the cleaning system of a animal litter box. More particularly, the present invention relates to a customizable liner and a sifter set.

The said liner is tightly fitted at the bottom, around the sides and the top opening of the custom designed animal litter box, and acts as a barrier between the litter and the animal litter box. The said sifter is also tightly fitted at the bottom, around the sides and the top opening of the custom designed animal litter box but acts as filtering mechanism, with its more than 200 slits will separate the clean litter from the animal waste. In the separation process, the clean litter sifts through the slits on the bottom and sides into the animal litter box and the solid animal waste and clumped litter remain in the sifter.

### BACKGROUND OF THE INVENTION

Animal litter boxes are generally used to maintain the waste of animals in the house. An animal litter box must be regularly cleaned to maintain its hygiene and cleanliness. If the litter box waste gets out of control it is an unpleasant experience to both the pet and the pet owner. Conventionally, the animal litter box comes in various shapes such as square, round or rectangular structure with an open top end.

The litter box is typically filled with a few inches of a very fine gravel like substance called “kitty litter”, to provide a soft and comfortable feel for animals to go to the bathroom and bury their waste.

Animal waste sticks to plastic. Unfortunately, it's just not about scooping which is bad enough, but at some point you are going to have to change that litter which means scraping all the excess waste which is stuck to the bottom and sides and then scrubbing out the litter box with hot soapy water.—Weekly!

Thus the need for a liner was born. Liners have been around and used in animal litter boxes for at least 40 years. A typical liner comes in the form of a plain flexible square plastic bag with an opening at the top with 2 drawtapes.

Litter liners are generally used to separate the litter box and the litter and also help in easy clean-up of the litter box. This also helps in maintaining hygiene and dryness in the litter box. They are removed from the litter box periodically to dispose of the old and contaminated litter. It is normal for animals to scratch the hard plastic box if not covered using liners. Thus, litter liners also prevent the direct contact between the animal and the hard plastic litter box. However, several available liners are made-up of thin plastic and an animal can easily poke & shred the thin liners. For example, many times an animal will dig holes in the litter to bury their waste. During this process, animal claws may get caught in the plastic liner resulting in damage to plastic liners and ejection of dirty litter out side the litter box. This mess must be cleaned by the animal owner as well. Moreover, these small holes/openings in the thin plastic liners allow the urine to reach to the bottom of the litter box creating an unpleasant situation. The unhealthy and unpleasant odor from the saturated urine is extremely annoying for both the pet and pet owner. This dirty and unpleasant environment inside the litter box discourages the animal to use the litter box for elimination and the pet starts seeking clean locations for elimination—like your carpet. Current liners on the market are between 0.5 mil-2.0 mil. The present invention is 3.0 mil.

Sizing: Generally, the current liners are either too large or too small. Small ones are totally useless because they are too small and won't fit into the average litter box. You are then forced into buying the larger ones. However, the larger ones are generally way too large and the animal winds up clawing the entire liner into the litter box and peeing & crapping all over it defeating the purpose of the liner to begin with. A custom made liner for a specific litter box solves that problem.

Scooping, the highlight of anyone's day.

Generally speaking, keeping a litter box constantly clean is challenge every animal owner must face and the majority of pet owners ultimately discard all the litter at once. Sometimes it's easier to throw out the entire batch of litter instead of digging out all the waste. This leads to wastage of clean litter, an economically costly step for the pet owner. However, the most traditional method of cleaning litter is to remove the waste using a scooper. A scooper is a small plastic hand shovel with holes. Scooping smelly waste out of a litter box is a disgusting experience but it's an absolute necessity or your home will smell like a cesspool.

A sifter is supposed to replace a scooper and the entire scooping experience.

There are 3 types of sifters on the market.
1. Thin square sheets of plastic, the size of a large poncho with some holes in the center. This is supposed to be secured to the litter box by a large rubber band. (Petco's Sophresh brand.)
2. Hard plastic litter box & sifter combinations have also been around a bit and have their own drawbacks and usability issues as well. For example, the animal waste sticks in the small holes and crevices of the hard plastic sifter and thus requires frequent scrubbing by the pet owner. (Walmart's Vibrant brand.)
3. On the high end, there are big and expensive electronic self-cleaning machines available. However, they suffer from major issues as well: 1. Since they are electric, you have to find an electrical outlet which makes your litter box limited in where you can put it. 2. The electric motor makes unpleasant noises which disturbs some pets enough where they won't go near it or the sensors malfunction requiring you to dig out the waste by hand. 3. If the electric device is working properly, soft wastes still gets caught in the metal rake or cleaning apparatus requiring you to again, manually dig out the waste by hand. (Litter Robot 3.)

Our custom sifter solves all these problems as it has over 200 slits for fast drainage of clean litter. Just gather up the drawtapes, do the shimmy shake to strain the litter and dispose.

A real timesaver. Cleaning accumulated litter takes time and may require a bare minimum of 5 minutes. The average person may not be able to hold their breath for that long. As a result, they are stuck with the inhaling all that waste smell until the job is complete. With this invention, the whole cleanup process can be accomplished in a few short seconds.

According to the FDA, an unhygienic litter box filled with animal waste is a causative factor for several infections such as Toxoplasmosis and Salmonella poisoning.

In digging in the litter box and scooping litter, you should protect yourself by using protective accessories such as gloves, masks, eye protection & face shields. With the current invention you should not need any of these items as exposures are kept to a bare minimum.

As a result, the present invention strives to solve all the existing shortcomings of the prior art with a biodegradable, customizable liner and sifter set that helps in hassle-free cleaning of the animal litter box.

Another objective of the present invention is to provide a user-friendly liner wherein the said liner is made up of a customizable, thick, flexible, disposable biodegradable plastic. The said customizable liner is opaque and can be constructed in any shape, size, thickness, and color.

the customizable liner also has a pet friendly printed design.

The most important aspect of the present invention is to provide a liner & sifter with a flat bottom that fits perfectly into any bottom of various shape litter pans. For instance, the flat bottom liner & sifter can be customized to fit into a square, circle, oblong, or triangular litter pan.

### BRIEF DESCRIPTION OF THE DRAWINGS

The skilled artisans in the field of scooping litter will readily appreciate the foregoing aspects of the present invention after reading the illustrative embodiments in conjunction with the drawings in which;

FIG. 1 describes the process of separation of clean litter and animal waste using the liner and sifter combination, according to an exemplary embodiment of the present invention;

FIG. 2 is the top view of a customizable liner.

FIG. 3 is the top view of a customizable sifter.

FIG. 4 is the side view of a customizable liner.

FIG. 5 is the side view of a customizable sifter.

FIG. 6 is the bottom view of a customizable liner.

FIG. 7 is the bottom view of a customizable sifter.

NOTE—FIGS. 8-13 comprise of 3 different designs that will accomplish the same result of a customized liner and sifter.

FIG. 8 describes the design of a Cross-shaped liner with flat bottom and 4 drawtapes.

FIG. 9 describes the design of a Cross-shaped sifter with flat bottom and 4 drawtapes.

FIG. 10 describes the design of a H-shaped liner with flat bottom and 4 drawtapes.

FIG. 11 describes the design of a H-shaped sifter with flat bottom and 4 drawtapes.

FIG. 12 describes the design of a 2 piece Oblong shaped liner with oblong shaped ring sides and 4 drawtapes.

FIG. 13 describes the design of a 2 piece Oblong shaped sifter with oblong shaped ring sides and 4 drawtapes.

### DETAILED DESCRIPTION OF THE DRAWINGS

Reference will now be made to the drawings wherein like numerals refer to like parts throughout. Exemplary embodiments presented below describes a litter box liner and a litter box sifter wherein the said liners and sifters have different shapes such as rectangular, square, oblong, and cross-shaped. Exemplary embodiments of the present invention describe the functioning of a litter box liner without foldovers and having customizable shapes (rectangular, square, oblong, and cross-shaped) and can tightly fit into the animal litter box. Skilled artisan will readily appreciate that the disclosed liner and sifter combination can have several applications based on the context and usefulness.

Unless defined otherwise, all technical and scientific terms used herein have the same meaning as commonly understood by one of ordinary skill in the art to which the invention pertains. Although a number of methods and materials similar or equivalent to those described herein can be used in the practice of the present invention, the preferred materials and methods are described herein.

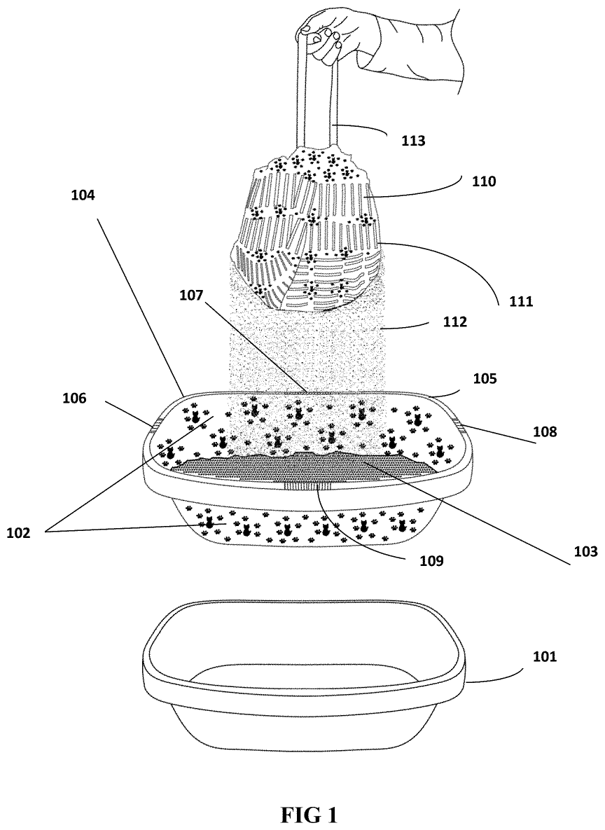

FIG. 1 describes the process of separation of clean litter and animal waste. In the preferred embodiments, a combination of a customized, form fitted liner and a customized, form fitted sifter and a custom litter box.

101 This invention starts with a custom litter box specifically designed to work with a customized, form fitted liner and customized, form fitted sifter set system.
102 is the customized, form fitted liner. The customized, form fitted liner fits and secures itself into the custom litter box 101.
103 is a customized, form fitted flat bottom liner that is placed in the custom animal litter box 101. The customized, form fitted flat bottom helps prevent the animal from grabbing and shedding the excess plastic from the bottom of the litter box. In this image it just so happens that it has recycled litter from the custom, form fitted sifter above. This is the completed cycle of action for this invention.
104 is a customized, form fitted side panel. Form fitted sides helps prevent the animal from grabbing and shedding any excess plastic from the sides of the litter box.
105 is a customized, form fitted drawtape that helps secure the tight fit of the liner around the entire top of the litter box.
106, 107, 108 and 109 are the customized, form fitted drawtape handles. For easy 1 step gathering, secure closure and easy disposal.
110 is the customized, form fitted sifter which separates all the waste.
111 The sifter also has over 200 that allow easy passage of the clean granular litter 112 back into the custom litter box 101 to be reused.
112 is the clean granular litter falling back into the custom litter box 101 to be reused.
are the 4 customized drawtape handles that are gathered up together to lift the dirty sifter out of the litter box and with a little shaking & gravity, the clean litter falls down to the litter box 101 and the dirty litter is separated out to be disposed. We recommend a “clumpable” type of litter for optimum functioning of the liner & sifter combination.

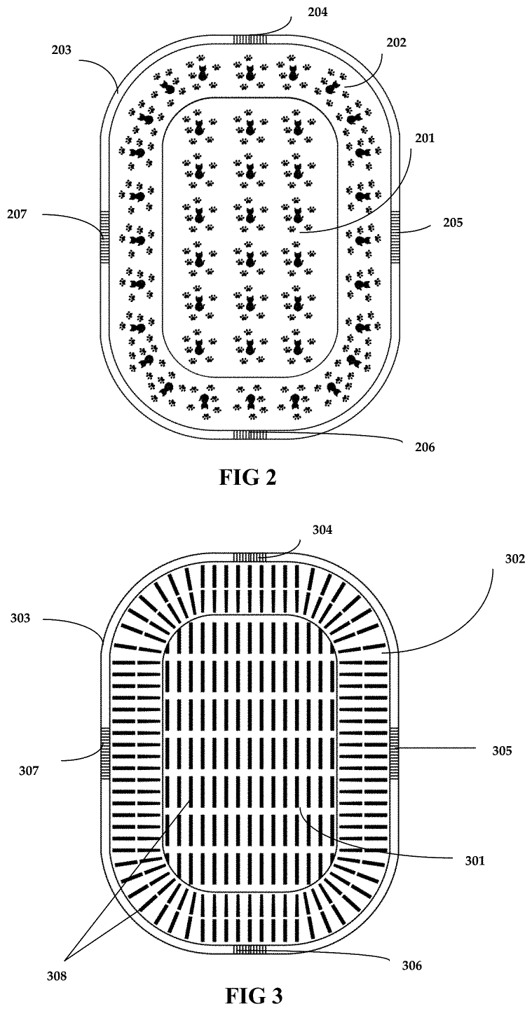

FIG. 2 is the top view of a customizable, form fitted liner. that is placed in the custom animal litter box 101.

201 The customized, form fitted flat bottom helps prevent the animal from grabbing and shedding the excess plastic from the bottom of the custom litter box 101.
202 is a customized, form fitted side panel. Form fitted sides helps prevent the animal from grabbing and shedding any excess plastic from the sides of the custom litter box.
203 is a customized, form fitted drawtape that helps secure the tight fit of the liner around the entire top of the litter box.
204, 205, 206 and 207 are the customized, form fitted drawtape handles. For easy 1 step gathering, secure closure and easy disposal.

FIG. 3 is the top view of a customized, form fitted sifter. The customized, form fitted sifter has approximately 200 slits sized 2.0 inches long by ⅜ inches wide. This design maximizes the speed of which the clean litter can be separated from animal waste.

301 is the customized, form fitted, flat bottom of the sifter. It has approximately 100 slits that allow easy passage of the clean granular litter 110 to fall back into the litter box 101 to be reused. A customized, form fitted bottom also helps prevent the animal from grabbing and shedding any excess plastic from the sides of the litter box.
302 is the customized, form fitted, sides of the sifter. It also has approximately 100 slits that allow easy passage of the clean granular litter 110 to fall back into the litter box 101 to be reused. Form fitted sides also helps prevent the animal from grabbing and shedding any excess plastic from the sides of the litter box.
303 is a customized, form fitted drawtape that helps secure the tight fit of the customized, form fitted sifter around the entire top of the litter box.
304, 305, 306 and 307 are the customized, form fitted drawtape handles. The drawtape handles are used to gather up and lift the dirty sifter out of the litter box and with a little shaking & gravity, the clean litter falls down to the litter box 101 and the dirty litter is separated out to be disposed.
308 The customized, form fitted sifter has approximately 200 slits sized 2.0 inches long by ⅜ inches wide. This design maximizes the speed of which the clean litter can be separated from animal waste.

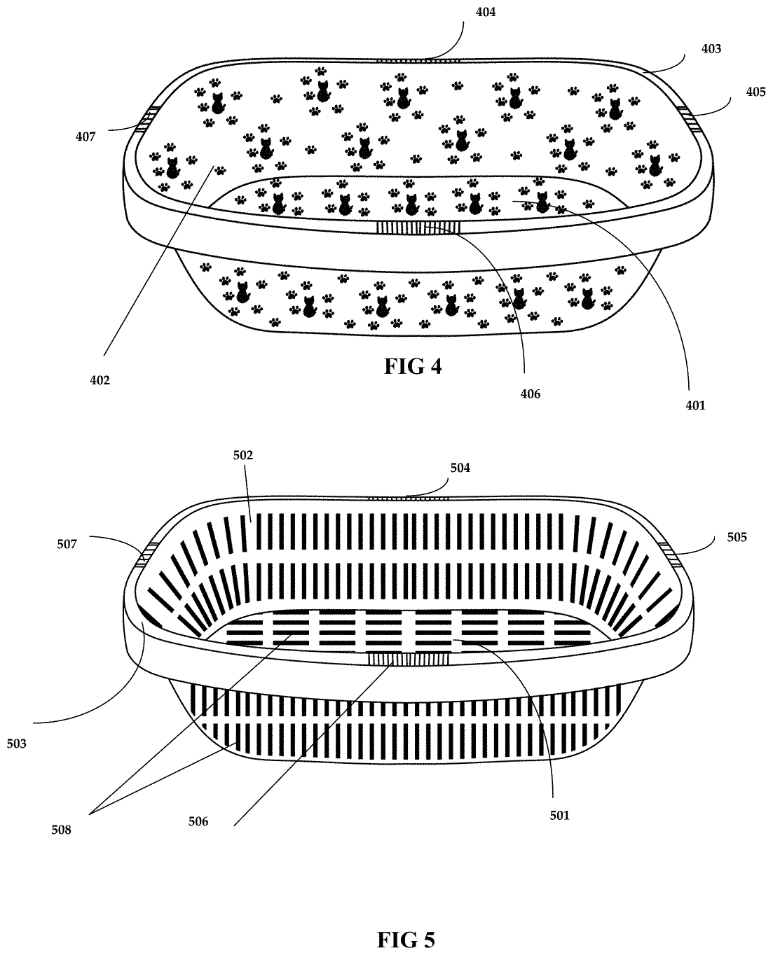

FIG. 4 is the side view of a customized, form fitted liner.

401 The customized, form fitted flat bottom helps prevent the animal from grabbing and shedding the excess plastic from the bottom of the custom litter box 101.
402 is a customized, form fitted side panel. Form fitted sides helps prevent the animal from grabbing and shedding any excess plastic from the sides of the custom litter box.
403 is a customized, form fitted drawtape that helps secure the tight fit of the liner around the entire top of the litter box.
404, 405, 406 and 407 are the customized, form fitted drawtape handles. For easy 1 step gathering, secure closure and easy disposal.

FIG. 5 is the side view of a customized, form fitted sifter. The customized, form fitted sifter has approximately 200 slits sized 2.0 inches long by ⅜ inches wide. This design maximizes the speed of which the clean litter can be separated from animal waste.

501 is the customized, form fitted, flat bottom of the sifter. It has approximately 100 slits that allow easy passage of the clean granular litter 110 to fall back into the litter box 101 to be reused. A customized, form fitted bottom also helps prevent the animal from grabbing and shedding any excess plastic from the sides of the litter box.
502 is the customized, form fitted, sides of the sifter. It also has approximately 100 slits that allow easy passage of the clean granular litter 110 to fall back into the litter box 101 to be reused.
Form fitted sides also helps prevent the animal from grabbing and shedding any excess plastic from the sides of the litter box.
503 is a customized, form fitted drawtape that helps secure the tight fit of the customized, form fitted sifter around the entire top of the litter box.
504, 505, 506 and 507 are the customized, form fitted drawtape handles. The drawtape handles are used to gather up and lift the dirty sifter out of the litter box and with a little shaking & gravity, the clean litter falls down to the litter box 101 and the dirty litter is separated out to be disposed.
508 The customized, form fitted sifter has approximately 200 slits sized 2.0 inches long by ⅜ inches wide. This design maximizes the speed of which the clean litter can be separated from animal waste.

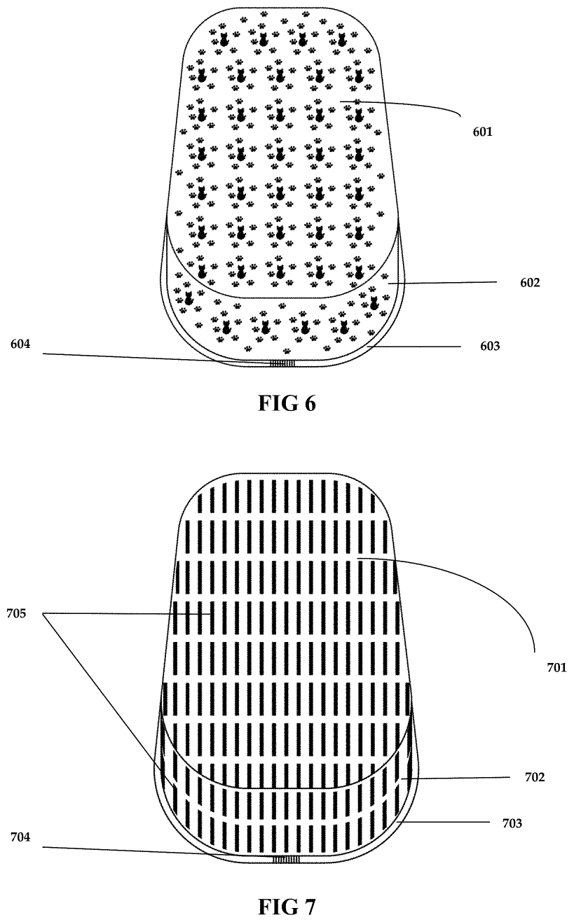

FIG. 6 is the bottom view of a customized, form fitted liner.

601 The customized, form fitted flat bottom helps prevent the animal from grabbing and shedding the excess plastic from the bottom of the custom litter box 101.
602 is a customized, form fitted side panel. Form fitted sides helps prevent the animal from grabbing and shedding any excess plastic from the sides of the custom litter box.
603 is a customized, form fitted drawtape that helps secure the tight fit of the liner around the entire top of the litter box.
604, is the customized, form fitted drawtape handle. For easy 1 step gathering, secure closure and easy disposal. 605, 606, & 607 handles are not visible in this drawling.

FIG. 7 is the bottom view of a customized, form fitted sifter. The customized, form fitted sifter has approximately 200 slits sized 2.0 inches long by ⅜ inches wide. This design maximizes the speed of which the clean litter can be separated from animal waste.

701 is the customized, form fitted, flat bottom of the sifter. It has approximately 100 slits that allow easy passage of the clean granular litter 110 to fall back into the litter box 101 to be reused. A customized, form fitted bottom also helps prevent the animal from grabbing and shedding any excess plastic from the sides of the litter box.
702 is the customized, form fitted, sides of the sifter. It also has approximately 100 slits that allow easy passage of the clean granular litter 110 to fall back into the litter box 101 to be reused. Form fitted sides also helps prevent the animal from grabbing and shedding any excess plastic from the sides of the litter box.
703 is a customized, form fitted drawtape that helps secure the tight fit of the customized, form fitted sifter around the entire top of the litter box.
704, is the customized, form fitted drawtape handle. For easy 1 step gathering, secure closure and easy disposal. 705, 706, & 707 handles are not visible in this drawling.
705 The customized, form fitted sifter has approximately 200 slits sized 2.0 inches long by ⅜ inches wide. This design maximizes the speed of which the clean litter can be separated from animal waste.

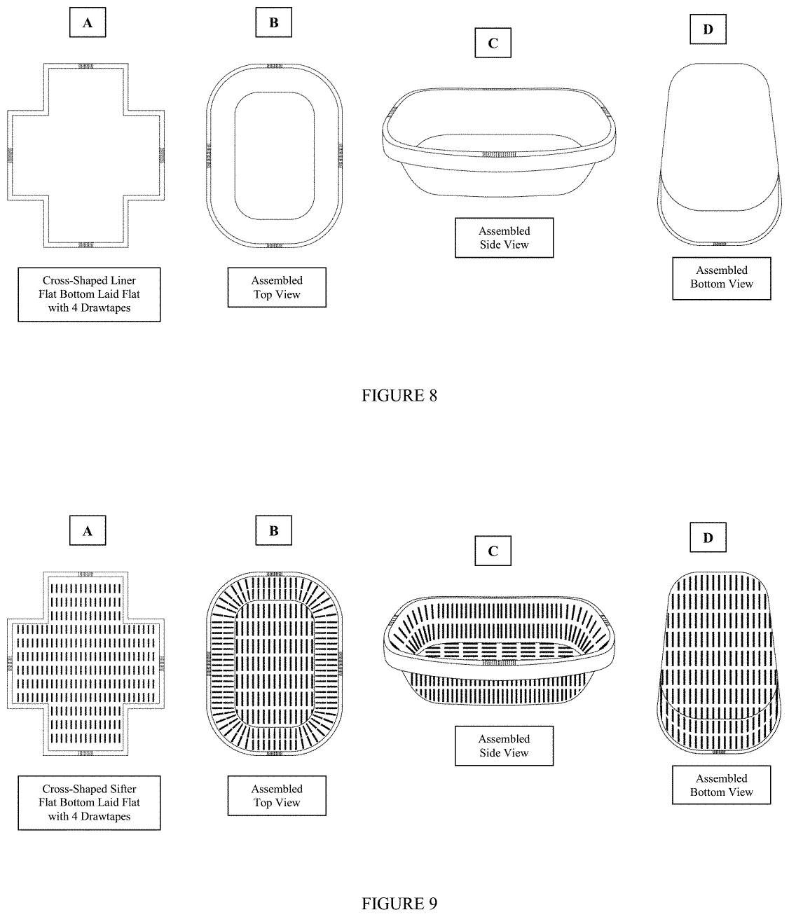

FIG. 8 describes a cross-shaped liner with 4 drawtapes (FIG. 8A). The cross-shaped liner can be easily fixed on an animal litter box with a final shape of flat bottom. FIG. 8 shows the top (FIG. 8A), side (FIG. 8B), and bottom view (FIG. 8C) of the said liner.

FIG. 9 describes a cross-shaped sifter with sifter slits and 4 drawtapes (FIG. 9A). The cross-shaped sifter can be easily fixed on an animal litter box with a final shape of flat bottom. FIG. 9 shows the top (FIG. 9B), side (FIG. 9B), and bottom view (FIG. 9C) of both the said sifter.

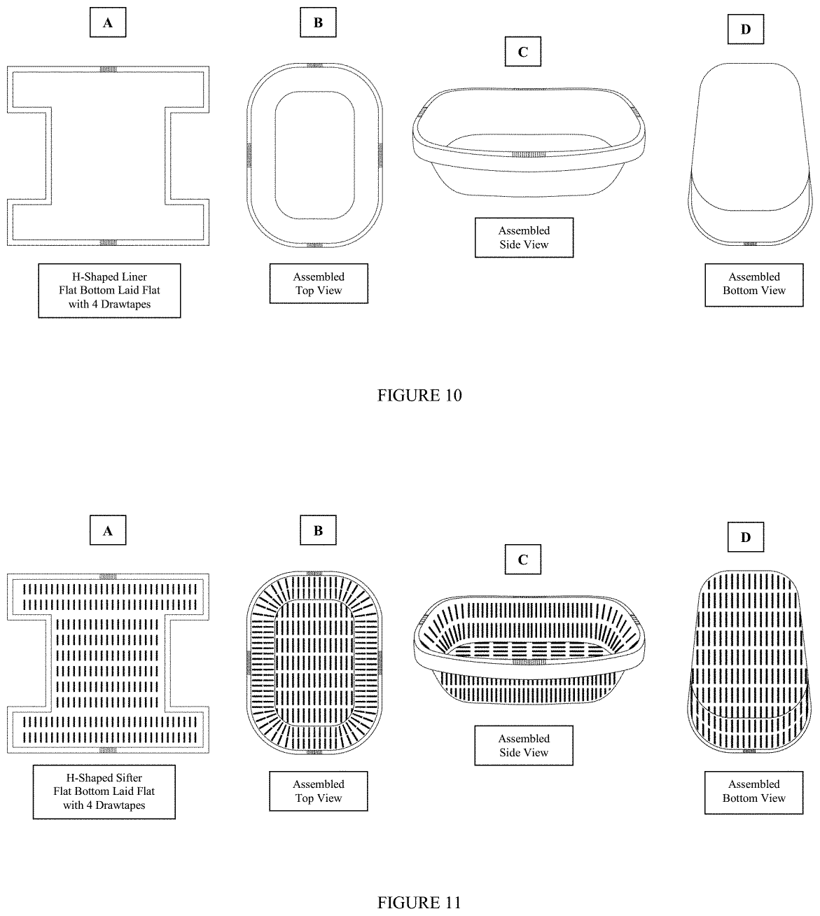

FIG. 10 illustrates the design of an H-shaped liner (FIG. 10A) with 2 drawtapes. The H-shaped liner can be easily fixed on an animal litter box with a final shape of flat bottom. FIG. 10 shows the top (FIG. 10B), side (FIG. 10C), and bottom view (FIG. 10D) of the said liner.

FIG. 11 illustrates the design of an H-shaped sifter (FIG. 11A) with sifter slits and 2 drawtapes. The H-shaped sifter can be easily fixed to an animal litter box with a final shape converts into a flat-bottom sifter. FIG. 11 shows the top (FIG. 11B), side (FIG. 11C), and bottom view (FIG. 11D) of the said sifter.

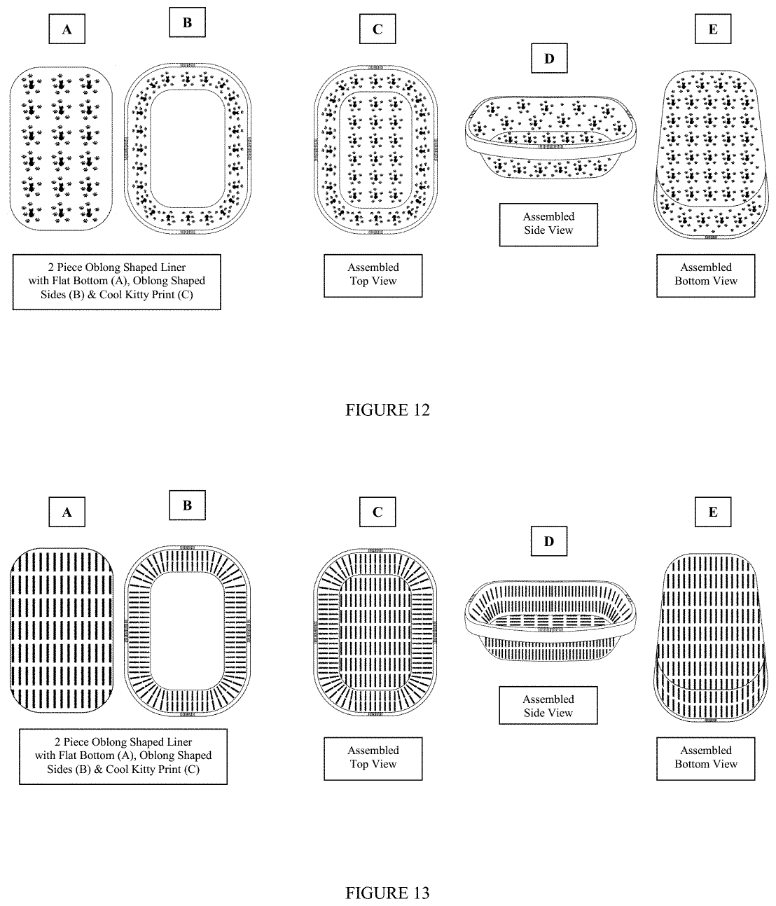

FIG. 12 illustrates the design of a flat oblong bottom, oblong ring sides, and 4 drawtapes of a liner. The liner is constructed using three pieces: A flat oblong bottom, oblong ring sides, and 4 drawtapes.

FIG. 13 illustrates the design of a flat oblong bottom, oblong ring sides, and 4 drawtapes of a sifter. The said sifter has over 200 slits which allow passage of clean litter and stops clumped litter and solid animal waste. In a preferred embodiment, the sifter has 8 rows and each slit measuring ⅜ wide×2.0 inches long with ½ inch gap in between the rows.

### DESCRIPTION OF THE PREFERRED EMBODIMENT OF THE INVENTION

In one of the preferred embodiments, referring to FIG. 1, a animal litter box 101 with a normal body portion and outer edge is shown to explain the normal functioning of a liner and sifter combination of the present invention. In one of the preferred embodiments, the size of the litter box 101 is 20.5″ L×16.0″ W×6.0″ H. A customized, form fitted flat bottom liner 102 of same size is placed in the animal litter box 101. Then, a customized, form fitted flat bottom sifter 110 of same size is placed in the animal litter box 101 Even though the present customized, form fitted liner & sifter invention is for a specific sized litter box, the liner and sifter combination disclosed in the present invention is also made to custom fit a wide-range of other animal litter boxes with various sizes, shape, and dimensions, including but not to (Table 1). It is preferred that the liner 102 is made using flexible and customizable plastic. However, other commonly used alternatives are within the general scope of the present invention. Drawtape handle 105 helps in the proper fixing of the customized liner 102 on the said animal litter box 101. A pet lover can periodically lift the customized sifter placed in the animal litter box using handle 113. In the preferred embodiment Approximately 168 sifter holes 111 helps in the removal of clean and dry litter from animal waste. In the preferred embodiment, the sifter has 8 rows and each slit measuring ⅜ wide×2.0 inches long with ½ inch gap in between the rows. The clumping of litter happens due to urine excreted by the animal. The clean and dry litter 112 falls back into the animal litter box and can be easily reused. The customized sifter thus helps in easy removal of animal waste and clumped litter from the clean, dry, uncontaminated litter in less than 10 seconds.

### SUMMARY OF THE INVENTION

In accordance with the principles of the present invention, a customized, form fitted liner is disclosed which comprises a customized, form fitted flat bottom, and customized, form fitted side portions that are continuous with the bottom portion; and the side portions take the shape of the side walls on the animal litter box when fitted into the litter box. The liner tightly fits into the litter box and has 2-4 handle drawtapes that are an integral part of lifting the liner out of the litter box for easy disposal of both litter and waste.
According to another embodiment of the present invention, a litter box sifter with perforated bottom slits and perforated side walls slits are disclosed. The sifter tightly fits into the litter box and has 2-4 handle drawtapes that are an integral part of lifting the sifter out of the litter box for easy disposal of just the waste.

TABLE 1
The novel customizable liner and sifter of the present invention are also specifically
made & designed for the following Animal litter box models.

| Number | Model | Dimensions (L × W × H) |
|---|---|---|
| 1 | Amazon Basics Large Hooded Litter box | 23.7 × 17.8 × 16.7 |
| 2 | Amazon Basics Standard Hooded Litter box | 20.6 × 15.6 × 15.0 |
| 3 | Amazon Basics No Door | 19.8 × 17.5 × 26.1 |
| 4 | Amazon Basics Triangle Litter Box | 26.3 × 20.2 × 22.6 |
| 5 | Amazon Basics Top Entry Litter Box | 20.1 × 15.4 × 15.0 |
| 6 | Animaze Enclosed Animal litter box | 17.6 × 22.8 × 16.8 |
| 7 | Arm & Hammer Wave Litter Pan-Small | 14.3 × 11.0 × 4.0 |
| 8 | Arm & Hammer Wave Litter Pan-Large | 18.7 × 15.2 × 5.4 |
| 9 | Arm & Hammer Wave Litter Pan-Jumbo | 21.1 × 16.6 × 6.6 |
| 10 | Arm & Hammer Hi-Back Wave Litter Pan | 19.3 × 16.7 × 9.3 |
| 11 | Arm & Hammer Rimmed Wave Litter Pan | 18.7 × 15.5 × 10.6 |
| 12 | Arm & Hammer Hooded Wave Litter Pan-Large | 19.3 × 16.3 × 18.1 |
| 13 | Arm & Hammer Hooded Wave Litter Pan-Jumbo | 22.6 × 11.9 × 18.1 |
| 14 | Arm & Hammer Top Entry Litter Pan | 20.0 × 15.0 × 15.0 |
| 15 | Aspen Pet Booth Step Litter Box | 24.0 × 20.0 × 19.0 |
| 16 | Booda Dome Covered Litter Box | 18.0 × 18.0 × 16.5 |
| 17 | Booda Clean Step Litter Box | 20.0 × 19.0 × 24.0 |
| 18 | Booda The Best Dome Cleanstep Animal Box | 20.0 × 24.0 × 19.0 |
| 19 | Catit Animal Litter Box With Rim | 22.2 × 16.3 × 11.3 |
| 20 | Catit Hooded Animal litter box | 22.4 × 18.3 × 15.3 |
| 21 | Catit Jumbo Hooded Animal Litter Pan | 22.4 × 18.3 × 17.0 |
| 22 | Catit Magic Blue Litter Box Jumbo | 22.4 × 18.3 × 19.7 |
| 23 | Clevercat Top Entry Litter Pan | 20.0 × 15.0 × 15.0 |
| 24 | Custom Kitty Liners | 20.5 × 16.0 × 6.0 |
| 25 | Destinie Booda Dome Cleanstep Animal Box, Pearl Covered Litter Dome, New | 20.0 × 24.0 × 19.0 × 21.0 |
| 26 | Dimaka Stainless Steel Litter Box | 17.5 × 14.0 × 6.0 |
| 27 | Doskocil Litter Pan-Large | 18.5 × 15.25 × 5.25 |
| 28 | Doskocil Petmate Litter Pan | 18.5 × 15.3 × 5.0 |
| 29 | Expawlorer Stainless Steel Large Animal litter box | 21.0 × 13.0 × 6.0 |
| 30 | Frisco Open Top Animal litter box With Rim Large by Chewy | 19 inches |
| 31 | Frisco Flip Top Hooded Animal litter box, Gray, Rim Large by Chewy | 22 inches |
| 32 | Frisco High Back Litter Box, Extra Large by Chewy | 23 inches |
| 33 | Frisco High Side Animal litter box, Extra Large by Chewy | 24 inches |
| 34 | Frisco Deluxe Hooded Animal litter box with Scoop, Extra Large by Chewy | 25 inches |
| 35 | Frisco Hooded Animal litter box, Extra Large by Chewy | 26 inches |
| 36 | Frisco Top Entry Animal litter box Gray, Extra Large by Chewy | 23 inches |
| 37 | iPrimio Ultimate Stainless Steel Animal XL Litter Box | 23.5 × 15.5 × 6.0 |
| 38 | iPrimio Animal litter box, Non-stick Plated Stainless Steel XL Litter Pan | 23.5 × 15.5 × 6.0 |
| 39 | iPrimio Ultimate Stainless Steel Animal XL Litter Box-with enclosures | 23.5 × 15.5 × 6.0 |
| 40 | IRIS Ellipse Animal litter box | 19.68 × 15.51 × 10.63 |
| 41 | IRIS High Sided Open Litter Pan | 18.88 × 14.88 × 7.94 |
| 42 | IRIS Clean Pet Animal Kitty Open Top With Litter Scoop | 19.0 × 15.0 × 11.75 |
| 43 | IRIS Open-top Pet Animal litter box with Shield and Scoop and Removable Shield | 15.0 × 18.7/8 × 11.11/16 |
| 44 | IRIS Large Split-Hood Litter Box with Scoop and Grate | 19.0 × 15.0 × 15.5 |
| 45 | IRIS Large Hooded Litter Box with Scoop | 19.0 × 15.0 × 15.06 |
| 46 | IRIS Jumbo Hooded Animal litter box with Scoop | 21.0 × 18.75 × 17.0 |
| 47 | IRIS Open Corner Top Animal litter box with Litter Scoop | 20.75 × 16.25 × 7.5 |
| 48 | IRIS Corner Jumbo Hooded Animal litter box with Animal Litter Scoop | 21.0 × 16.13 × 14.25 |
| 49 | IRIS Top Entry Animal litter box & Scoop | 20.5 × 14.75 × 14.38 |
| 50 | IRIS Top Entry Animal litter box-Large | 20.47 × 16.14 × 14.56 |
| 51 | IRIS USA Premium Top Entry Animal litter box | 17.5 × 17.5 × 14.5 |
| 52 | Lucky Champ | 16.75 × 25.0 × 9.0 |
| 53 | Marchiro Goa Animal Litter Pan | 16.5 × 12.5 × 4.25 |
| 54 | Marchiro Goa Animal Litter Pan-Large | 19.25 × 14.25 × 5.0 |
| 55 | Marchiro Free Maxi Covered Animal Litter Pan with filter and Odor Flap | 27.5 × 17 × 17.75 |
| 56 | Marchiro Bill F Covered Litter Pan with Filter-Small-Medium | 19.75 × 15.75 × 16.5 |
| 57 | Marchiro Nora 2C Litter Pan for Animals | 13.75 inches |
| 58 | Moderna Litter Pan for Dogs | 19.5 × 14.5 × 5.0 |
| 59 | Moderna Litter Pan for Dogs-Large | 24.0 × 20.0 × 5.0 |
| 60 | Moderna Animal Litter Tray | 12 × 16.7 × 3.9 |
| 61 | Moderna Flip Animal litter box | 19.7 × 15.4 × 14.6 |
| 62 | Moderna AC60-0331-0040 | 23.0 × 19.0 × 19.0 |
| 63 | Moderna Mega Comfy Enclosed Grey Litter Box for Animals-Large | 25.9 × 19.4 × 18.0 |
| 64 | Moderna Trendy Cat | 22.6 × 17.5 × 17.2 |
| 65 | Moderna Mega Smart Cat Blue XL | 21.3 × 15.7 × 16.1 |
| 66 | ModKat Litter Box | 15.9 × 15.9 × 14.6 |
| 67 | ModKat Litter Tray | 20.0 × 14.0 × 15.0 |
| 68 | Nature's Miracle Advanced High Sided Corner Litter Box | 26.0 × 23.0 × 10.0 |
| 69 | Nature's Miracle Advanced High Sided Litter Box, Eay Clean Spout | 23.4 × 18.2 × 11.0 |
| 70 | Good's Fun Nature's Miracle Advanced Hooded Corner Litter Box | 26.0 × 23.0 × 11.0 |
| 71 | Nature's Miracle Oval Hooded Flip Top Litter | 25.1 × 19.1 × 11.8 |
| 72 | Ohmaker's Ohm Box-Stainless Steel Litter Box, Extra Large | 23.5 × 15.5 × 6.1 |
| 73 | Pidan Studio Snow House Igloo Covered Dog Proof Animal litter box-Buda | 21.6 × 19.3 × 21.6 |
| 74 | So Phresh Small Open Kitten Litte Box-Petco | 14.0 × 10.0 × 3.5 |
| 75 | So Phresh Animal Litter Pan with Microban-Petco | 21.75 × 16.75 × 6.5 |
| 76 | So Phresh Litter Box Starter Bundle-Petco | 19.5 × 14.75 × 4.25 |
| 77 | So Phresh Jumbo Open Litter Box-Petco | 22.0 × 16.5 × 6.5 |
| 78 | So Phresh High-Back Litter Box-Petco | 23.0 × 19.0 × 12.0 |
| 79 | So Phresh Sanimalter Shield High-Back Litter Box-Petco | 24.0 × 18.0 × 10.0 |
| 80 | So Phresh High-Back Corner Grey Litter Box-Petco | 26.25 × 21.5 × 10.0 |
| 81 | So Phresh Corner Privacy Hood & Animal Litter Pan-Petco | 22.0 × 17.88 × 15.25 |
| 82 | So Phresh jumbo Enclosed Animal Litter-Petco | 23.0 × 19.0 × 19.0 |
| 83 | So Phresh Navy Top-entry Litter Box-Petco | 23.25 × 15.5 × 15.13 |
| 84 | So Phresh Open Cat Litter Box Large-Petco | 19.3/8 × 143/8 × 4.5 |
| 85 | So Phresh Open Cat Litter Box X-Large-Petco | 22.5 × 5.5 × 17.0 |
| 86 | So Phresh Small Animal Litter Pan & Scoop Set-Petco | 12.5 × 10.0 × 5.8 |
| 87 | Pet Fusion Large Litter Box | 22.6 × 18.1 × 8.0 |
| 88 | PetMate Litter Pan Kitty Starter, Large | 18.6 × 15.4 × 5.0 |
| 89 | PetMate Litter Pan | 14.0 × 10.5 × 3.5 |
| 90 | PetMate Litter Pan | 16.0 × 12.0 × 4.0 |
| 91 | PetMate Litter Pan | 18.5 × 15.3 × 5.0 |
| 92 | PetMate Litter Pan | 22.0 × 16.5 × 6.5 |
| 93 | PetMate Basic Litter Pan | 14.0 × 10.5 × 3.5 |
| 94 | PetMate Jumbo Litter Pan | 22.3 × 16.8 × 6.8 |
| 95 | PetMate Large Animal Litter Pan with Rim | 18.9 × 15.0 × 4.7 |
| 96 | PetMate Large Animal Litter Pan with Rim | 19.43 × 15.6 × 7.04 |
| 97 | PatMate 42306 Arm & Hammer Large Sifting | 18.9 × 15.2 × 7.9 |
| 98 | PetMate Jackson Galaxy Giant Open Litter Pan | 25.8 × 18.0 × 10.0 |
| 99 | PetMate Skirted Animal Litter Pan | 21.93 × 16.34 × 6.5 |
| 100 | PetMate Basic Hooded Animal litter box | 18.8 × 16.3 × 18.5 |
| 101 | PetMate Stay Fresh Jumbo Hooded Pan | 181 × 21.2 × 19.5 |
| 102 | PetMate Corner Open Litter Pan for Animals | 26.0 × 19.0 × 19.0 |
| 103 | PetMate 42101 Sifting Corner Litter Pan | 26.0 × 11.7 × 19.0 |
| 104 | PetMate Hooded Corner Litter Pan | 26.0 × 19.0 × 19.4 |
| 105 | PetMate Booda Dome Litter Box | 17.5 × 17.5 × 17 |
| 106 | PetMate Booda Dome Clean Step Litter Box | 21.0 × 21.0 |
| 107 | PetMate Booda Dome Clean Step Litter Pan Pearl Linen | 32.0 × 22.9 × 21.8 |
| 108 | PetMate Booda Dome Pearl Litter Box | 18.64 × 18.64 × 9.82 |
| 109 | PetMate 22793 Retracting Litter Pan Brushed Nickel | 19.2 × 23.7 × 16.7 |
| 110 | PetSmart Great Choice Open Pan Litter-Large | 18.6 × 15.3 × 5.2 |
| 111 | PetSmart Great Choice Open Pan Litter-XL | 22.6 × 16.8 × 6.7 |
| 112 | PetSmart Great Choice Open Rim Litter | 22.1 × 17.1 × 17.1 |
| 113 | PetSmart Whisker City Starter Kit Animal litter box | 18.9 × 15.3 × 8.0 |
| 114 | PetSmart Whisker City Hooded Kit Animal litter box-Large | 18.8 × 15.2 × 14.0 |
| 115 | PetSmart Whisker City Hooded Kit Animal litter box-Jumbo | 24.0 × 19.0 × 18.5 |
| 116 | PetSmart Whisker City Jumbo Premium Hooded Kit Animal Litter Pan | 24.0 × 19.0 × 18.5 |
| 117 | Van Nees Animal Pan Medium | 16.0 × 12.0 × 4.0 |
| 118 | Van Ness Cat Pan Large | 18.3/8 × 14.7/8 × 5.0 |
| 119 | Van Nees Animal Pan Giant | 22.0 × 16.0 × 6.5 |
| 120 | Van Nees CP4 Large Framed Cat Pan | 19.0 × 15.1 × 4.2 |
| 121 | Van Nees CPS Sifting Cat Pan Litter Box with Frame | 19.0 × 15.13 × 8.0 |
| 122 | Van Nees Large High Sides Animal Litter Pan | 17.5 × 15.0 × 9.0 |
| 123 | Van Nees, Animal litter box | 20.5 × 17.0 × 10.0 |
| 124 | Van Nees, Animal Pan | 19.5 × 15.25 × 17.0 |
| 125 | Van Nees, Sifting Enclosed Animal Litter Pan | 21.5 × 17.5 × 19.0 |
| 126 | Van Nees, Odor Control Extra Giant Enclosed Animal Pan with Odor Door | 21.5 × 17.5 × 18.0 |
| 127 | Van Nees, Enclosed Pan with Door | 55.12 × 27.18 × 44.2 |
| 128 | Van Nees Odor Control Extra Giant Translucent Enclosed Animal Pan with Odor Door | 22.0 × 17.5 × 18.0 |
| 129 | Van Ness Corner Enclosed Animal Pan, Silver Large | 20.5 × 19.5 × 14.0 |
| 130 | Verreska Domed Animal litter box Kitty Litter Box Cute | 22.0 × 21.6 × 17.7 |
| 131 | Yangbaga Stainless steel Litter Box for Animal and Rabbit | 23.5 × 15.5 × 6.0 |
| 132 | Walmart Vibrant Life Fit Fur Size Animal litter box | 18.375 × 15.0 × 5.125 |
| 133 | Walmart Vibrant Life Extra Large Animal Litter Pan | 16.38 × 22.0 × 5.0 |
| 134 | Walmart Vibrant Life Sanimalter Shield Animal Litter Tray | 18.875 × 15.25 × 7.25 |
| 135 | Walmart Vibrant Life High Sided Hideout Litter Box | 21.625 × 17.5 × 9.125 |
| 136 | Walmart Secret Sandbox Animal litter box | 21.75 × 17.75 × 18.125 |
| 137 | Walmart Vibrant Life Mega Smart Animal Cove Covered Litterbox | 21.0 × 18.0 |

We claim:

1. A customizable, form fitting animal litter box liner comprising:
(i) A flat bottom portion that tightly fits into the bottom portion of the custom animal litter box;

2. (ii) Side portions that tightly fit the side walls of the custom litter box and that are continuous to the bottom portion of the said liner.

3. The customizable, form fitting animal litter box liner of claim 1 wherein the said liner further comprising a drawtape border and drawtape handles wherein the drawtape handles help in proper closing of the liner on the animal litter box.

4. The customizable, form fitting liner of claim 1 wherein the said liner is available in various shapes including, but not limited to, H shaped, cross shaped, and oblong shaped.

5. The litter box liner of claim 1 wherein the thickness of liner is 3 mils. But could be any thickness.

6. A customizable, form fitting sifter that is placed on top of the animal litter box liner claimed is claim 1.

7. The customizable, form fitting sifter of claim 5 wherein the said sifter allows the separation of clean, uncontaminated litter from clumped, contaminated litter.

8. The customizable, form fitting sifter of claim 5 wherein the said sifter is available in various shapes including, but not limited to, H shaped, cross shaped, and oblong shaped.

9. The customizable, form fitting sifter of claim 5 wherein the said sifter contains a plurality of sifting openings at the bottom of the sifter and allows the passage of clean litter when lifted using handles.

10. The customizable, form fitting sifter of claim 5 wherein the said sifting openings of the said sifter are of specific dimensions. The said sifter has over 200 slits which allow passage of clean litter and stops clumped litter and solid animal waste. In a preferred embodiment, the sifter has 8 rows and each slit measuring ⅜ wide×2.0 inches long with ½ inch gap in between the rows. However, the number and size of each slit can be any number and size.

11. The customizable, form fitting sifter of claim 5 wherein the said sifter is preferably used in combination with the litter liner of claim 1.

12. The combination of claim 8 wherein the said combination of a liner and a sifter primarily helps in maintaining cleanliness and hygiene of the animal litter box, preferably a animal litter box.

13. The customizable, form fitting sifter of claim 5 wherein the cleaning process using the said sifter is very quick and completes in less than 10 seconds.
